(19) United States
(12) Patent Application Publication
(10) Pub. No.: US 2021/0123145 A1
(43) Pub. Date: Apr. 29, 2021

(54) ELECTROCHEMICAL PROCESS FOR THE PRODUCTION OF PRESSURIZED GASEOUS HYDROGEN BY ELECTROLYSIS THEN DEPOLARIZATION

(71) Applicant: ERGOSUP, Malataverne (FR)

(72) Inventors: Elisa GRINDLER, Malataverne (FR); François GUILLET, Malataverne (FR); Vincent BIZOUARD, Malataverne (FR)

(73) Assignee: ErgOsup, Malataverne (FR)

(21) Appl. No.: 17/041,473

(22) PCT Filed: Apr. 3, 2019
(86) PCT No.: PCT/FR2019/050772

§ 371 Date: Sep. 25, 2020

(30) Foreign Application Priority Data
Apr. 3, 2018 (FR) 18 52883

(51) Int. Cl. C25B 1/04; C25C 1/16; C25C 1/08; C25B 11/046; C25B 5/00

(52) U.S. Cl. CPC C25B 1/04; C25C 1/16; C25B 5/00; C25B 11/046; C25C 1/08

(57) ABSTRACT

An electrochemical process comprises a step E^{l} of electrolysis of an electrolyte in order to produce gaseous oxygen and a step of converting oxidation-reduction chemical energy into electrical energy with production of H₂. The electrolyte comprises M^{m+} ions of a metal M corresponding to the redox pair (M^{m+}/M), and A^{a+} ions of a depolarization additive A corresponding to a redox pair (A^{a+}/A). Current is supplied between the anode and the cathode, A^{a+} and M^{m+} are deposited on the cathode respectively in the form of A and M during the electrolysis and gaseous oxygen is released at the anode. The supply of current between the anode and the cathode is then cut off. Depolarization occurs corresponding to the conversion step C°, with production of H₂ and dissolution of M and A into M^{m+} and A^{a+} at the electrode acting as the cathode during step E^{l} and the produced H₂ is collected.

### TECHNICAL FIELD

The field of the invention is that of the electrochemical production of pressurized gaseous hydrogen.

In particular, the invention relates to an electrochemical process for the production of gaseous hydrogen by electrolysis followed by electrochemical conversion of If ions into gaseous hydrogen by depolarization.

The invention also relates to a device for implementing such a hydrogen production process, as well as a kit comprising the device and some or all of the consumables useful in said process.

### PRIOR ART—TECHNICAL PROBLEM

Hydrogen is the cleanest and most efficient fuel for generating energy, in a fuel cell as well as in an internal combustion engine.

These qualities are particularly valuable in applications using hydrogen as a fuel for transport vehicles, in which the hydrogen stored in the vehicle produces kinetic energy by means of an internal combustion engine fueled by hydrogen and/or by means of an electric motor powered by an on-board fuel cell consuming hydrogen.

Moreover, the storage of energy in the form of pressurized hydrogen is also particularly advantageous.

Hydrogen is an invisible, odorless, and non-toxic gas. Its consumption in a fuel cell produces only electrical energy and water, while its combustion does not lead to harmful by-products.

The most economical and therefore the most widely used method for producing hydrogen is the steam reforming of natural gas.

Production of hydrogen by the electrolysis of water is much more restricted because it is much more expensive.

In this context, hydrogen appears to be the most suitable energy vector to support an energy transition, in particular to enable clean transportation as well as the storage of energy.

To achieve this, the hydrogen must be made from electricity and water: this involves the conventional processes of alkaline electrolysis or solid polymer electrolyte membrane electrolysis (Proton Exchange Membrane), or those under development such as high-temperature electrolysis. The use of hydrogen in the context of clean transportation requires the ability to store pressurized hydrogen in tanks on board vehicles, at high pressures ranging from 200 to 700 bar.

The conventional method is to compress the gas with a mechanical compressor; this is an expensive operation and requires numerous maintenance operations.

Hydrogen refueling stations already exist for land vehicles. This hydrogen may be produced centrally and then distributed to distribution stations, or may be directly produced on site at the distribution station. On-site production is particularly attractive in terms of logistics.

Moreover, from an ecological perspective, it would be interesting if this hydrogen production were carried out by electrolysis, on site as well as centrally.

It turns out, however, that currently the hydrogen pressures reached at the outlet of the electrolyzer do not exceed 80 bar.

Numerous and fruitless attempts have therefore been made to exceed this ceiling.

Some of these attempts have consisted of designing devices aimed at providing a solution to this technical problem of producing hydrogen at high pressure. Such devices are described for example in the following patents U.S. Pat. No. 4,758,322A1, U.S. Pat. No. 6,153,083A1, DE 9115337.9 U. These various known devices have several disadvantages which arise from the necessity of having to manage not only the supply of power to the electrodes, but also complex fluidics with inlets and outlets for liquids and gases.

These known devices encounter the limiting factor of having to simultaneously manage the two gases resulting from the electrolysis, oxygen and hydrogen, with the essential requirement of ensuring complete separation of the two gases for safety reasons.

To overcome this limitation, patent application US 2004 0211679A1 describes a method of performing electrochemical compression at the outlet of the electrolyzer, in a second device. This technical proposal has the disadvantage of making the production process more complex, and therefore more expensive.

The limitation of simultaneously managing the oxygen and hydrogen specific to the electrolysis of water was able to be eliminated in the process according to patent FR2948654B1. This process provides for an electrolysis decoupled into two steps. A metal salt (zinc, nickel, or manganese) is used in an electrolytic cell in order to decouple the water electrolysis reaction into two steps. Firstly, the process stores electricity by depositing a metal on the cathode and releasing oxygen at the anode of the electrolytic cell. Secondly, the electrolytic cell operates as a battery, allowing the dissolution of said metal and the production of hydrogen. This process is used to store electricity, and release it in the form of hydrogen.

This decoupling of the production of hydrogen and oxygen is made possible by the use of the intermediate vector consisting of a metal ion/metal redox pair.

The decoupling of the electrolysis of water is also described in the following patent applications:
CN105734600A (electrolysis in basic medium). The intermediate vector is a Redox pair E°(NiO₂/Ni(OH)₂)=−0.49 V between that of water [E°(O₂/OH⁻)=0.4 V in basic medium] and that of hydrogen [E°(H₂O/H₂)=−0.83 V in basic medium]
WO2013068754A1 & WO2016038214A1 (electrolysis in acidic medium).

This decoupling of the process,

on the one hand, into an electrolysis step leading to the storage of energy in chemical form, and, on the other hand, into a step of converting this stored electrochemical energy into electrical energy with the concurrent release of gaseous hydrogen,

makes it possible to collect gaseous hydrogen under a higher pressure than that obtained with the devices of the prior art mentioned above.

However, the industrialization and streamlining of the production of pressurized gaseous hydrogen require substantial improvements in terms of the attainable pressure without sacrificing the constraints of simplicity, economy, and safety.

### OBJECTIVES OF THE INVENTION

In these circumstances, the invention aims to satisfy at least one of the objectives set out below.
One of the essential objectives of the invention is to provide an improved process for the electrochemical production of pressurized gaseous hydrogen, in a decoupled manner, in order to achieve high pressures of gaseous hydrogen, for example >80 bar.
One of the essential objectives of the invention is to provide an improved process for the electrochemical production of pressurized gaseous hydrogen, in a decoupled manner, and without sacrificing industrial safety requirements.
One of the essential objectives of the invention is to provide an improved and economical process for the electrochemical production of pressurized gaseous hydrogen, in a decoupled manner.
One of the essential objectives of the invention is to provide an improved process for the electrochemical production of pressurized gaseous hydrogen, in a decoupled manner and while respecting environmental constraints.
One of the essential objectives of the invention is to provide an improved process for the electrochemical production of pressurized gaseous hydrogen, in a decoupled manner and which can be implemented in a non-industrial environment and not under the control of specialized operators, in other words at a gaseous hydrogen distribution site, completely independently.
One of the essential objectives of the invention is to provide an industrial device that is reliable, efficient, economical, and robust, for implementing the process referred to in one of the above objectives.

### BRIEF DESCRIPTION OF THE INVENTION

These objectives, among others, are achieved by the present invention, which firstly relates to an electrochemical process for the production of pressurized gaseous hydrogen, characterized in that it consists essentially of implementing, in at least one chamber, at least one step E^{l} of electrolysis of an electrolyte comprising at least one solvent, preferably aqueous, this electrolysis step E^{l} converting electrical energy into chemical energy, with production of gaseous oxygen in a chamber E^{l}, and at least at least one step C° of converting this chemical energy into oxidation-reduction energy with production of gaseous hydrogen in a closed chamber C° that is identical to or different from, preferably identical to, to chamber E^{l};
wherein:
   the electrolyte comprises M⁺ ions, M corresponding to the redox pair (M^{m30} /M), and A^{a+} ions of at least one depolarization additive A corresponding to a redox pair (A^{a+}/A) where:
      the absolute value of the overvoltage of the hydrogen evolution reaction on the metal M is greater than the difference Eₜₕ(H⁺/H₂)−Eₜₕ(M^{m+}/M) in acidic medium or Eₜₕ(H₂O/H₂)−Eₜₕ(M^{m+}/M) in basic medium;
      Eₜₕ(A^{a+}/A)<Eₜₕ(H⁺/H₂) in acidic medium;
      Eₜₕ(A^{a+}/A)<Eₜₕ(H₂O/H₂) in basic medium;
      m is an integer; preferably between −5 and 5, and more preferably between −4 and 4;
      a is an integer; preferably between −5 and 5, and, more preferably between −4 and 4;
      the absolute value of the overvoltage of the hydrogen evolution reaction on the metal A is less than the difference Eₜₕ(H⁺/H₂)−E(M^{m+}/M) in acidic medium or Eₜₕ(H₂O/H₂)−Eₜₕ(M^{m+}/M) in basic medium;
   the electrolysis step E^{l} is initiated by supplying current between the anode and the cathode;
   A^{a+} and M^{m+} are respectively deposited in the form of A and M on the cathode during the electrolysis step E^{l} and gaseous oxygen is released at the anode;
   the electrolysis step E^{l} is stopped by cutting off the supply of current between the anode and the cathode;
   local depolarization effects then appear between A, M, and the H⁺ ions, said effects leading to the production of gaseous hydrogen and dissolution of M and A into M^{m+} and A^{a+} at the electrode which serves as cathode during step E^{l}; which corresponds to the conversion step C°;
   the gaseous hydrogen thus produced is collected, preferably under a pressure P^{Hyd};
   the gaseous hydrogen thus collected is possibly stored outside the chamber.

The process according to the invention is particularly efficient and advantageous in that it consists of carrying out an electrochemical compression integrated with the electrolysis of an electrolyte, preferably aqueous and even more preferably water, so as to directly produce very highly pressurized hydrogen in a decoupled manner, by means of an intermediate vector consisting of a Redox pair (M^{m+}/M) in the presence of the depolarizing agent (A^{a+}/A), in two independent steps: electrolysis with release of oxygen, then oxidation of M to M^{m+} and of A to A^{a+} with release of hydrogen.

The simplification this brings and the accompanying economic gains constitute a significant technological advance compared with the state of the art in this field of the production of gaseous hydrogen by electrochemical means.

Advantageously, M is a metal compound composed of at least one metal and/or at least one compound based on at least one metal, for example a metal oxide.

The process according to the invention makes it possible to achieve hydrogen pressures greater than 80 bar. This is a minimum to be reached in order for large-scale applications in the field of transportation to be conceivable.

In a context of industrial production, it is essential that this manufacture of pressurized hydrogen be carried out in strict compliance with safety rules. In this regard, one of the key points is the explosiveness of the mixture of gaseous hydrogen/oxygen.

Through these innovative arrangements, the process according to the invention, and more generally the system according to the invention which comprises the process and the device, perfectly integrates this safety constraint.

In another of its aspects, the invention relates to a device for implementing the process.

This device comprises:
a) at least one closed chamber E^{l} intended to contain at least one electrolyte;
b) at least cathode intended to be immersed in the electrolyte;
c) at least one anode intended to be immersed in the electrolyte;
d) a power supply connected to the cathode and to the anode;
e) at least one gas discharge pipe equipped with at least one valve, this discharge pipe preferably subdividing into at least one pipe intended for discharging gaseous oxygen, possibly mixed with gaseous hydrogen, and into at least one pipe intended for discharging gaseous hydrogen; each of these pipes being equipped with at least one valve;
f) possibly means for increasing the G/L interface;
g) possibly means for circulating the electrolyte in the chamber;
h) possibly means for heating the electrolyte in the chamber.

This simple and effective device has the particular advantage of having one or more chambers each comprising at least one electrochemical cell preferably including only a cathode and an anode. This simplicity makes it possible to consider, relatively without qualms, a proliferation of electrochemical cell units in order to produce large quantities of hydrogen within a minimum amount of space.

Another object of the invention relates to a kit for implementing the process, comprising a device and at least some of the components for preparing the electrolyte or electrolytes intended to be contained in the chamber or chambers of the device.

Definitions
Throughout this disclosure, any singular designates a singular or a plural.
The definitions given below as examples may serve in interpreting this disclosure:
   “electrolyte” : aqueous or ionic liquid solution containing ions A⁺, M^{m+}, Y^{y+}, Y^{y-}, H⁺, OH⁻
   “acidic electrolyte”: pH<7 (+/−0.1)
   “basic electrolyte”: pH>7 (+/−0.1)
   “E^{OH}”: standard electrode potential. The standard electric potentials E° referred to in this disclosure are all measured under the same conditions (reference, temperature, concentrations).
   “Eₜₕ”: thermodynamic potential of the electrochemical reaction.
   “E”: out-of-equilibrium potential of the electrochemical reaction, equal to the sum of the thermodynamic potential and the overvoltage of the electrochemical reaction.
   “decoupled”: defines the process as being implemented in two separate and independent steps: the first of these steps being an electrolysis leading to deposition of a material reduced at the cathode, this deposition constituting a storage of electrochemical energy; while the second step is a step of oxidation of the materials deposited at the electrolysis cathode with production of gaseous hydrogen by reduction of H⁺ ions;
   “about” or “substantially” means within plus or minus 10%, or even plus or minus 5%, relative to the unit of measurement used;
   “between Z1 and Z2” means that one and/or the other of the endpoints Z1, Z2 is or is not included in the interval [Z1, Z2].

### DETAILED DESCRIPTION OF THE INVENTION

Process

The electrochemical compression specific to the process according to the invention is part of a process with two decoupled and independent steps, namely, the electrolysis E^{l} of the electrolyte (preferably an aqueous solution) on the one hand, and on the other hand an oxidation reaction of the species deposited at the cathode during electrolysis, concurrently with the production of hydrogen by reduction of the H⁺ ions contained in the electrolyte.

The invention uses, among other things, the property of the metals or alloys M selected according to the invention of blocking the evolution of hydrogen when one of their Mⁿ⁺ salts is electrolyzed. This is the phenomenon called hydrogen overvoltage, leading to an out-of-equilibrium electrochemical state.

The step E^{l} of electrolysis of the electrolyte, carried out in the presence of these Mⁿ⁺ salts, leads to oxygen evolution at the anode, to deposition of the metal M at the cathode, and to an accumulation of energy corresponding to the out-of-equilibrium state.

During the electrochemical conversion step C°, a return to equilibrium enables the release of hydrogen. The metal (or alloy) M is oxidized into the salt of Mⁿ⁺. The gaseous hydrogen is released by releasing the energy accumulated during the electrolysis step E^{l}.

One of the keys to the present invention is the addition of chemical elements in the form of ions or molecules A^{a+} in the electrolyte before the electrolysis step E^{l}. This depolarization additive formed by the Redox pair (A^{a+}/A) makes it possible to achieve the return to equilibrium specific to step C° and therefore this hydrogen evolution during step C°, without using a hydrogen electrode. This use of at least one depolarization additive contributes to controlling the kinetics, through the concentrations of the ionic species A^{a+} and M^{m+} introduced into the electrolyte. The concentrations can be adjusted according to the application.

The mechanism involved is as follows: during step E^{l}, the ion or molecule A^{a+} is co-deposited in metal form A with the metal M during step E^{l}. Preferably, step E^{l} is stopped when the local depolarization effects appear. Then, during step C°, the local depolarization effects form between A, M, and the H⁺ ions, which accelerates the dissolution of the metal M and the hydrogen evolution.

Electrolyte,

According to the invention, the electrolyte is preferably an acidic or basic aqueous solution, or an ionic liquid.

According to a preferred procedure, the electrolyte is an aqueous saline solution further comprising at least one Bronsted-Lowry acid or base for which the counterion is preferably identical to the ion of the salt M and/or of A.

The Mm⁺ ions of the electrolyte are preferably ions of a single metal M.

According to a noteworthy arrangement of the invention, M is a metal, preferably chosen from the group comprising—ideally composed of: Zn, Cd, Sn, Ni, Mn, Fe, Pb, Co, Hg, their alloys, and mixtures thereof; Zn being particularly preferred.

Advantageously, the ions of the metal M are supplied to the electrolyte by at least one precursor, preferably chosen from the group comprising—ideally composed of: salts, in particular sulfates, oxides, nitrates, chlorides, citrates, phosphates, carbonates, fluorides, Xbromides, aqueous hydroxide solutions of alkali metals or alkaline earth metals, and mixtures thereof.

In accordance with the invention, the metal M is chosen such that it can be deposited on the cathode during the electrolysis step E^{l}, with the electrolyte considered, with the best possible yield. Preferably, this means that the absolute value of the overvoltage of the hydrogen evolution reaction on the metal M is greater than the difference Eₜₕ(H⁺/H₂)—Eₜₕ(M^{m+}/M) in acidic medium and than the difference Eₜₕ(H₂O/H₂)−Eₜₕ(M^{m+}/M) in basic medium.

The electrolyte also contains A^{a+} ions, preferably of a single metal A.

A is different from M. A and M are distinguished from each other not only by their chemical nature but also by the thermodynamic electrochemical potentials Eₜₕ of their respective Redox pairs, which satisfy the inequalities mentioned above.

In a notable feature of the invention, A is a metal preferably chosen from the group comprising ideally composed of: Fe, Co, Sn, Ni, Ta, Mo, W, Pd, Rh, In, Ge, their alloys, and mixtures thereof; Fe and Ni being particularly preferred.

In an interesting variant of the invention, the ions of the depolarization additive A are supplied to the electrolyte by at least one precursor, preferably chosen from the group comprising—ideally composed of: salts, in particular sulfates, oxides, cyanates, phosphates, ammonias, nitrates, chlorides, hydrated ions, complex ions, and mixtures thereof; and more preferably from the complex ions in oxygenated, cyanated, ammoniated, or fluorosilicic form, and mixtures thereof.

This A^{a+} additive is a chemical element that meets the following criteria:
the thermodynamic potential of the redox pair (A^{a+}/A) is lower than that of the hydrogen evolution reaction:
   Eₜₕ(A^{a+}/A)<Eₜₕ(H⁺/H₂) in acidic medium;
   Eₜₕ(A^{a+}/A)<Eₜₕ(H₂O/H₂) in basic medium;
the absolute value of the overvoltage of the hydrogen evolution reaction on the metal A is less than the difference E°(H⁺/H₂)−E*(M^{m+}/M) in acidic medium and the difference E°(H₂O/H₂)−E°(M^{m+}/M) in basic medium;

Advantageously, the electrolyte is such that the ionic species [in particular H⁺,OH⁻] which it contains, other than M & A, are not reduced or oxidized during the two steps of the process. In other words, this means that these species other than M & A do not react electrochemically within a window of potentials bounded by the voltage of the electrode on which the A/B pair reacts and the voltage of the electrode on which the O₂/H₂O pair reacts in an acidic medium or O₂/OH⁻ in a basic medium.

At the start of step E^{l},
M^{m+} is present in the electrolyte within a range of concentrations between 0.1 and 15 mol.L⁻¹, preferably between 0.2 and 10 mol.L⁻¹
A^{a+} is present in the electrolyte within a range of concentrations between 10⁻⁵ and 1 mol.L⁻¹, preferably between 10⁻⁴ and 10⁻¹ mol.L⁻¹.

Electrochemical Cell

The electrolysis step E^{l} and the conversion step C° are carried out in at least one electrochemical cell, which comprises a chamber E^{l}C° containing the electrolyte in which at least one cathode and at least one anode are immersed.

During the electrolysis step E^{l} which takes place after supplying current to the anode and to the cathode, M^{m+} and A^{a+} are reduced to M & A and are deposited on the cathode.

Preferably, each chamber E^{l} comprises at least one cathode and at least one anode.

According to an advantageous arrangement of the invention, during the electrolysis step E^{l}, the supply of direct current delivers a current density i (A/m²) of between 100 and 5000, preferably 200 and 3000, and, more preferably 400 and 2000.

According to a noteworthy feature of the invention, the cathode is made from a material enabling deposition of the metal M with a Faraday efficiency of at least 30%, preferably at least 50%, this material preferably being selected from the group of metals and/or metal alloys comprising and ideally composed of: Al, Pb and Pb alloys, materials based on carbon, on nickel, and/or on iron, stainless steels, and combinations of these materials.

The gaseous oxygen resulting from oxidation of the water during the electrolysis step E^{l} is released in the vicinity of the anode.

Preferably, the anode is either made from a material chosen from the group of metals and/or metal alloys comprising and ideally composed of: Pb and Pb alloys, in particular Pb—Ag—Ca or Pb—Ag alloys, steels, iron, nickel, and combinations of these materials; or is composed of a dimensionally stable anode (DSA), or at least one oxide.

Process Variant for Increasing the Diffusion of Dissolved Hydrogen

According to one interesting possibility of the invention, the interface between the undissolved gas phase G and the liquid phase L—hereinafter referred to as the G/L interface—is increased at least during step C°, so as to accelerate the diffusion, from liquid phase to gas phase, of the dissolved hydrogen able to supersaturate the electrolyte.

This arrangement has the effect of remedying the limitation on the production of gaseous hydrogen, namely the solubilization of hydrogen in the electrolyte on the one hand, in particular in the electrolyte formed by an aqueous solution containing ions as well as H⁺ or OH⁻ ions, and on the other hand the supersaturation of the electrolyte with dissolved hydrogen.

Advantageously, the increase in the interface is carried out by implementing at least one of the following operations:
(i) forced circulation, which preferably consists of generating an electrolyte flow in chamber E^{l}C° or C°, more preferably using at least one pump so as to evacuate and replenish the gas bubbles present on the electrode or electrodes and on any roughnesses of chamber E^{l}C° or C°;
(ii) partial decompression, which consists of isolating the tank from the reactor for a certain time; then when the pressure in the reactor is sufficiently greater than that in the tank, a decompression of the reactor in the tank is performed, creating or increasing the supersaturation of H₂ in the electrolyte and therefore promoting the formation of bubbles;
(iii) spraying the electrolyte as fine droplets in the gases headspace of chamber E^{l}C° or C°,
(iv) at least one heating, preferably at least one localized heating, of the electrolyte, which advantageously consists of locally reducing the solubility of the dissolved gaseous hydrogen, thus promoting the nucleation of bubbles,
(v) subjecting the electrolyte to ultrasound to generate bubbles,
(vi) at least one depolarization, preferably at least one localized depolarization of the electrolyte, to locally increase supersaturation and promote the formation of bubbles,
(vii) making use of nanoparticles and/or at least one porous nucleation material in the electrolyte, to promote the nucleation of bubbles and increase the number of bubbles nucleation sites,
(viii) mechanical stirring of the electrolyte, which promotes the nucleation of bubbles by providing the energy necessary to counteract the surface tension.

Device

In another of its aspects, the invention relates to a preferred device for the first implementation, which comprises:
a) at least one closed chamber E^{l} intended to contain at least one electrolyte;
b) at least one cathode intended to be immersed in the electrolyte;
c) at least one anode intended to be immersed in the electrolyte;
d) a power supply connected to the cathode and to the anode;
e) at least one gas discharge pipe equipped with at least one valve, this discharge pipe preferably subdividing into at least one pipe intended for discharging gaseous oxygen, possibly mixed with gaseous hydrogen, and into at least one pipe intended for discharging gaseous hydrogen; each of these pipes being equipped with at least one valve;
f) possibly means for increasing the G/L interface;
g) possibly means for circulating the electrolyte in the chamber;
h) possibly means for heating the electrolyte in the chamber.

Kit

Another object of the invention is a kit for implementing the process. This kit is characterized in that it comprises:
the device according to the invention;
and the components for preparation of the electrolyte intended to be contained in the chamber of the device.

This kit, which forms a packaged unit for sale, may also comprise an explanatory insert for implementing the process using the device and components contained in this kit.

### EXAMPLE 1

The description of this example is made with reference to the appended figures, in which:

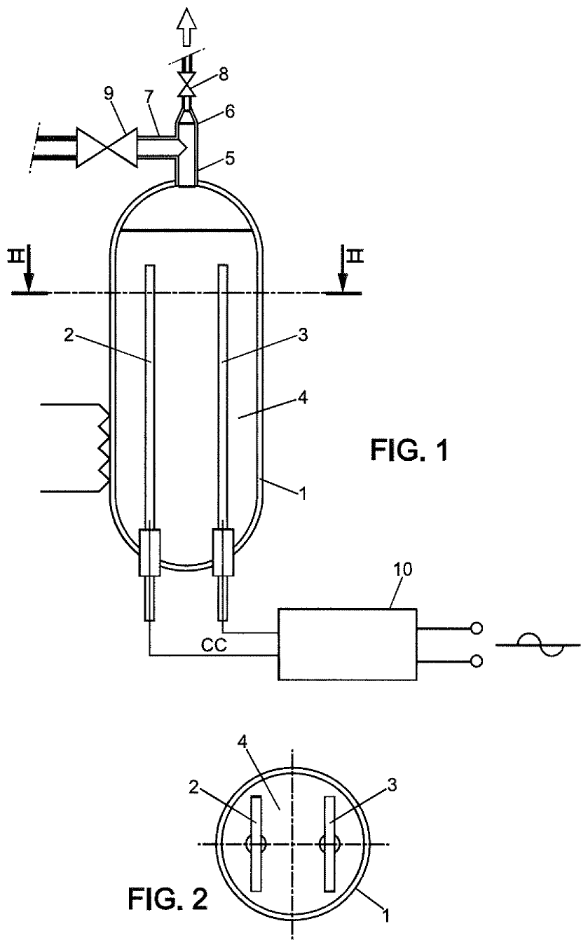

FIG. 1 is a schematic representation of the device for implementing the process according to the invention;

FIG. 2 is a straight cross-section along line II-II of FIG. 1.

The device shown in these figures comprises a high-pressure chamber 1, inside of which are arranged an anode 2 and a cathode 3, which are bathed in an electrolyte 4. This chamber 1 is a closed chamber provided with a gas outlet pipe 5, said pipe being subdivided into a pipe 6 for discharging gaseous hydrogen and a pipe 7 for discharging gaseous oxygen. Each pipe 6,7 is equipped with a valve 8,9, respectively the H₂ valve and O₂ valve, enabling the independent extraction of these two gases from the high-pressure chamber 1.

The anode 2 and the cathode 3 are connected to a DC generator 10, capable of supplying them with power in order to induce electrolysis.

Means 11 for heating the chamber 1 are schematically represented in FIG. 1.

The chamber 1, the anode 2, the cathode 3, and the electrolyte 4 form an electrolytic cell. For industrial production of pressurized gaseous hydrogen, this cell can be multiplied to increase production capacity.

In the following example, hydrogen was produced at 80 bar in an electrochemical reactor composed of a chamber 1 and two electrodes (anode 2, cathode 3) bathed in an acidic aqueous solution (electrolyte 4). The two electrodes, each with a surface area of 0.5 m², are as follows:
An electrode on which the deposition of metal takes place (cathode), made of aluminum (ref. EN AW 1050A H14 (Al≥99.5%));
An electrode on which oxygen is released (anode), made of lead-silver-calcium alloy (JL Goslar);

The electrolyte 4 is composed of zinc ions—metal M—(concentration 1.5 mol.L⁻¹), of sulfuric acid (1.5 mol.L⁻¹), and of iron sulfate salt—ion A⁺⁺—(8.4×10⁻⁴ mol.L⁻¹). The temperature is set at 30° C.

The electrolyte 4 is prepared by mixing 15.84 kg of sulfuric acid (37.5%, Brenntag) in 7.085 L of deionized water, then adding to this mixture 2.44 kg of ZnO (99.9%, Brenntag). 4.7 g of iron sulfate heptahydrate (99%, Sigma Aldrich) are then added to this solution.

Initially, the two electrodes 2 and 3 are immersed in the electrolyte 4. The oxygen valve 9 is open, and the hydrogen valve 8 is closed.

During the first electrolysis step C, the generator 10 delivers a current density of 595 A/m² for 2 hr, which makes it possible to deposit 653 g of metal M: zinc on the cathode (with an efficiency of 90%). Simultaneously, iron (depolarization additive A) is co-deposited at the cathode 3. Oxygen exits the chamber 1 through the outlet pipe 5 and the pipe 7 for which the valve 9 is in the open position.

In the second step C°, the power supply 10 is turned off and hydrogen begins to form. The H₂ gas leaving the chamber 1 initially contains oxygen and hydrogen; this mixture is sent via outlet pipe 5 and pipe 7 for which the valve 9 is in the open position, while the valve 8 of the H₂ pipe 6 is closed, in a capacity which allows diluting this mixture with another gas (argon for example). An O₂ sensor located in pipe 7 makes it possible to measure the O₂ content in the gas in real time. When it no longer contains oxygen, valve 9 is closed. The pressure P^{Hyd} of the hydrogen produced in chamber 1 increases as the gas is generated. When the desired pressure P^{Hyd} is reached, valve 8 is opened and the hydrogen is sent, via outlet pipe 5 and pipe 6, to a tank not shown in FIG. 1. The pressure P^{Hyd} inside the chamber 1 is measured using a pressure sensor.

The rate of the hydrogen evolution is 29 g/h/m², and it takes 1 hr24 to produce 20 g of hydrogen at 80 bar.

### EXAMPLE 2

An electrochemical cell was used to produce hydrogen at atmospheric pressure. The cell contains two compartments, separated by a polyester diaphragm. The first compartment contains the electrode which acts as the cathode in the first step, and a solution called the catholyte (1 L). The second compartment contains the electrode which acts as the anode in the first step, and a solution called the anolyte (1 L). Two circulation systems, each driven by a pump, replenish the electrolytes at a flow rate of 20 mL/min.

Description of operating conditions:
Compartment 1

| Catholyte | 12 g/L of Mn, 150 g/L of (NH₄)₂SO₄, | |
|---|---|---|
| | 20 mg/L of Co | |
| Cathode | Stainless steel 316, 1 m² | |
| Cathode current density | 485 | A/m² |

Compartment 2

| | |
|---|---|
| Anolyte | 12 g/L of Mn, 130 g/L of (NH₄)₂SO₄, |
| | 40 g/L of H₂SO₄ |
| Anode | Alloy of PbAg (1 mass % Ag), 0.485 m² |

Operating conditions

| Anode current density | 1000 | A/m² |
|---|---|---|
| Temperature | 40° | C. |
| Faraday efficiency | 65% | |
| Cell voltage | 5.5 | V |
| Deposition duration | 2 | hours |
| Amount of manganese | 645.75 | g |
| deposited | | |
| Amount of hydrogen | 23.52 | g |
| produced | | |

In the first step, the two electrodes are connected to a power supply which delivers a current of 10.9 A. The manganese is deposited at the cathode, and oxygen is released at the anode. Cobalt acts as a depolarizing additive; it is co-deposited with the manganese at the cathode. At the end of the first step, the power is cut off and hydrogen begins to be released at the stainless steel electrode. At the same time, the manganese oxidizes to Mn²⁺ ions and the cobalt to Co²⁺ ions.

1. Electrochemical process for the production of pressurized gaseous hydrogen, characterized in that it consists essentially of implementing, in at least one chamber, at least one step E^{l} of electrolysis of an electrolyte comprising at least one solvent, preferably aqueous, this electrolysis step E^{l} converting electrical energy into chemical energy, with production of gaseous oxygen in a chamber E^{l}, and at least one step C° of converting this chemical energy into oxidation-reduction energy with production of gaseous hydrogen in a closed chamber C° that is identical to or different from, preferably identical to, chamber E^{l};
wherein:
the electrolyte comprises M^{m+} ions, M corresponding to the redox pair (M^{m+}/M), and A^{a+} ions of at least one depolarization additive A corresponding to a redox pair (A^{a+}/A) where:
the absolute value of the overvoltage of the hydrogen evolution reaction on the metal M is greater than the difference Eₜₕ(H⁺/H₂)−Eₜₕ(M^{m+}/M) in acidic medium and than the difference Eₜₕ(H₂O/H₂)−Eₜₕ(M^{m+}/M) in basic medium;
Eₜₕ(A^{a+}/A)<Eₜₕ(H⁺/H₂) in acidic medium;
Eₜₕ(A^{a+}/A)<Eₜₕ(H₂O/H₂) in basic medium;
m is an integer; preferably between −5 and 5, and more preferably between −4 and 4
a is an integer; preferably between −5 and 5, and more preferably between −4 and 4
the absolute value of the overvoltage of the hydrogen evolution reaction on the metal A is less than the difference Eₜₕ(H⁺/H₂)−Eₜₕ(M^{m+}/M) in acidic medium and than the difference Eₜₕ(H₂O/H₂)−Eₜₕ(M^{m+}/M) in basic medium;
the electrolysis step E^{l} is initiated by supplying current between the anode and the cathode;
A^{a+} and M^{m+} are respectively deposited in the form of A and M on the cathode during the electrolysis step E^{l} and gaseous oxygen is released at the anode;
the electrolysis step E^{l} is stopped by cutting off the supply of current between the anode and the cathode;
local depolarization effects then appear between A, M, and the H⁺ ions, said effects leading to the production of gaseous hydrogen and dissolution of M and A into M^{m+} and A^{a+} at the electrode which serves as the cathode during step E^{l}; which corresponds to the conversion step C′;
The gaseous hydrogen thus produced is collected, preferably under a pressure P^{Hyd};
The gaseous hydrogen thus collected is possibly stored outside the chamber.

2. Process according to claim 1, wherein:
M is a metal, preferably chosen from the group comprising—ideally composed of: Zn, Cd, Sn, Ni, Mn, Fe, Pb, Co, Hg, their alloys, and mixtures thereof; Zn being particularly preferred;
A is a metal, preferably chosen from the group comprising—ideally composed of: Fe, Co, Sn, Ni, Ta, Mo, W, Pd, Rh, In, Ge, their alloys, and mixtures thereof; Fe and Ni being particularly preferred.

3. Process according to claim 1, characterized by at least one of the following:
The ions of the metal M are supplied to the electrolyte by at least one precursor, preferably chosen from the group comprising—ideally composed of: salts, in particular sulfates, oxides, nitrates, chlorides, citrates, phosphates, carbonates, fluorides, bromides, oxides, aqueous hydroxide solutions of alkali metals or alkaline earth metals, and mixtures thereof.
The ions of the depolarization additive A are supplied to the electrolyte by at least one precursor, preferably chosen from the group comprising—ideally composed of: salts, in particular sulfates, oxides, cyanates, phosphates, ammonias, nitrates, chlorides, hydrated ions, complex ions, and mixtures thereof; and more preferably from the complex ions in oxygenated, cyanated, ammoniated, or fluorosilicic form, and mixtures thereof.
The electrolyte is an aqueous saline solution further comprising at least one Bronsted-Lowry acid or base for which the counterion is preferably identical to the ion of the salt M and/or of A.

4. Process according to claim 1, wherein each chamber E^{l} comprises at least one cathode and at least one anode.

5. Process according to claim 1, wherein the cathode is made from a material enabling deposition of the metal M with a Faraday efficiency of at least 30%, preferably of at least 50%, this material preferably being selected from the group of metals and/or metal alloys comprising—and ideally composed of: Al, Pb and Pb alloys, materials based on carbon, on nickel, and/or on iron, stainless steels, and combinations of these materials.

6. Process according to claim 1, wherein the anode is either made from a material chosen from the group of metals and/or metal alloys comprising and ideally composed of: Pb and Pb alloys, in particular Pb—Ag—Ca or Pb—Ag alloys, steels, nickel, or iron, and combinations of these materials; or is composed of a dimensionally stable anode (DSA), or at least one oxide.

7. Process according to claim 1, wherein, during the electrolysis step E^{l}, the supply of direct current delivers a current density i (A/m²) of between 100 and 5000, preferably 200 and 3000, and more preferably 400 and 2000.

8. Process according to claim 1, wherein the interface between the undissolved gas phase G and the liquid phase L—hereinafter referred to as the G/L interface—is increased at least during step C°, so as to accelerate the diffusion, from liquid phase to gas phase, of the dissolved hydrogen saturating or even supersaturating the electrolyte.

9. Device for implementing the process according to claim 1, characterized in that it comprises:
a) at least one closed chamber E^{l} intended to contain at least one electrolyte;
b) at least one cathode intended to be immersed in the electrolyte;
c) at least one anode intended to be immersed in the electrolyte;
d) a power supply connected to the at least one cathode (b) and to the at least one anode (c);
e) at least one gas discharge pipe equipped with at least one valve, this discharge pipe preferably subdividing into at least one pipe intended for discharging gaseous oxygen, possibly mixed with gaseous hydrogen, and into at least one pipe intended for discharging gaseous hydrogen;
each of these pipes being equipped with at least one valve;
f) possibly means for increasing the G/L interface;
g) possibly means for circulating the electrolyte in the chamber;
h) possibly means for heating the electrolyte in the chamber.

10. A kit for implementing the process according to claim 1, wherein the kit includes:
a device comprising:
a) at least one closed chamber E^{l} intended to contain at least one electrolyte;
b) at least one cathode intended to be immersed in the electrolyte;
c) at least one anode intended to be immersed in the electrolyte
d) a power supply connected to the at least one cathode (b) and to the at least one anode (c);
e) at least one gas discharge pipe equipped with at least one valve, this discharge pipe preferably subdividing into at least one pipe intended for discharging gaseous oxygen, possibly mixed with gaseous hydrogen, and into at least one pipe intended for discharging gaseous hydrogen; each of these pipes being equipped with at least one valve;
f) possibly means for increasing the G/L interface;
g) possibly means for circulating the electrolyte in the chamber;
h) possibly means for heating the electrolyte in the chamber; and
components for preparing the electrolyte intended to be contained in the chamber of the device,
